(19) United States
(12) Patent Application Publication
(10) Pub. No.: US 2010/0157181 A1
(43) Pub. Date: Jun. 24, 2010

(54) LENS ARRAY DEVICE AND IMAGE DISPLAY

(75) Inventor: Kenichi TAKAHASHI, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: SONY CORPORATION, Tokyo (JP)

(21) Appl. No.: 12/632,573

(22) Filed: Dec. 7, 2009

(30) Foreign Application Priority Data
Dec. 22, 2008 (JP) 2008-326503
Mar. 16, 2009 (JP) 2009-063276

(51) Int. Cl. G02F 1/133; G02F 1/13

(52) U.S. Cl. 349/33; 349/200

(57) ABSTRACT

The lens array device includes: first and second substrates; a first electrode group formed on the first substrate to include transparent electrodes extending in a first direction; a second electrode group formed on the second substrate to include transparent electrodes extending in a second direction; and a liquid crystal layer with refractive index anisotropy arranged between the first and second substrates to produce a lens effect by changing the liquid crystal molecule alignment. The liquid crystal layer electrically changes into one of three states according to voltages applied to the first and second electrode groups. The three states include a state with no lens effect, a first lens state where a lens effect of a first cylindrical lens extending in the first direction is produced, and a second lens state where a lens effect of a second cylindrical lens extending in the second direction is produced.

The present application claims priority to Japanese Patent Application JP 2008-326503 filed in the Japanese Patent Office on Dec. 22, 2008 and Japanese Priority Patent Application JP 2009-063276 filed in the Japanese Patent Office on Mar. 16, 2009, the entire contents of which is hereby incorporated by reference.

### BACKGROUND OF THE INVENTION

1. Field of the Invention

The present invention relates to a lens array device allowed to electrically control the production of a lens effect through the use of a liquid crystal, and an image display which is electrically switchable between, for example, two-dimensional display and three-dimensional display through the use of the lens array device.

2. Description of the Related Art

In related art, a binocular or multi-ocular stereoscopic display which achieves stereoscopic vision by displaying parallax images to both eyes of a viewer has been known. Moreover, a method of achieving more natural stereoscopic vision is a spatial imaging stereoscopic display. In the spatial imaging stereoscopic display, a plurality of light rays with different emission directions are emitted into space to form a spatial image corresponding to a plurality of viewing angles.

As a method of achieving such a stereoscopic display, for example, a combination of a two-dimensional display such as a liquid crystal display and an optical device for three-dimensional display which deflects display image light from the two-dimensional display to a plurality of viewing angle directions is known. As the optical device for three-dimensional display, for example, a lens array in which a plurality of cylindrical lenses are arranged in parallel is used. For example, in the case of the binocular stereoscopic display, when right and left parallax images which are different from each other are displayed to eyes of the viewer placed side by side, a stereoscopic effect is obtained. To achieve the stereoscopic effect, a plurality of cylindrical lenses extending in a vertical direction are arranged in parallel in a lateral direction on a display surface of the two-dimensional display, and display image light from the two-dimensional display is deflected to the right and the left, thereby the right and left parallax images appropriately reach the right eye and the left eye of the viewer, respectively.

As such an optical device for three-dimensional display, for example, a microlens array formed by resin molding may be used. Moreover, a switching system lens array configured of liquid crystal lenses may be used. The switching system lens array configured of liquid crystal lenses is electrically switchable between a state in which the lens effect is produced and a state in which the lens effect is not produced, so switching between two display modes, that is, a two-dimensional display mode and a three-dimensional display mode is allowed to be performed by a combination of the two-dimensional display and the switching system lens array. In other words, in the two-dimensional display mode, the lens array is turned into the state in which the lens effect is not produced (a state in which the lens array does not have refractive power), and display image light from the two-dimensional display passes through as it is. In the three-dimensional display mode, the lens array is turned into the state in which the lens effect is produced (for example, a state in which the lens array has positive refractive power), and the display image light from the two-dimensional display is deflected in a plurality of viewing angle directions so as to achieve stereoscopic vision.

FIGS. 15 and 16 illustrate a first configuration example of the switching system lens array configured of the liquid crystal lenses. The lens array includes a first transparent substrate 221 and a second transparent substrate 222 which are made of, for example, a glass material and a liquid crystal layer 223 sandwiched between the first substrate 221 and the second substrate 222. A first transparent electrode 224 made of, for example, a transparent conductive film such as an ITO (Indium Tin Oxide) film is uniformly formed on substantially the whole surface on a side closer to the liquid crystal layer 223 of the first substrate 221. A second transparent electrode 225 is uniformly formed on substantially the whole surface on a side closer to the liquid crystal layer 223 of the second substrate 222 in the same manner.

The liquid crystal layer 223 has a configuration in which a mold with a concave lens shape is filled with liquid crystal molecules 231 by, for example, a manufacturing method called a photoreplication process. An alignment film 232 is planarly arranged on a side closer to the first substrate 221 of the liquid crystal layer 223. An alignment film 233 with a convex shape formed with a mold of a replica 234 is arranged on a side closer to the second substrate 222 of the liquid crystal layer 223. In other words, in the liquid crystal layer 223, an area between the planar alignment film 232 on a lower side and the alignment film 233 with the convex shape on an upper side is filled with the liquid crystal molecules 231, and the other area on the upper side is the replica 234. Thereby, in the liquid crystal layer 223, a part filled with the liquid crystal molecules 231 has a convex shape. The convex-shaped part is a part to selectively become a microlens in response to the application of a voltage.

The liquid crystal molecules 231 have refractive index anisotropy, and, for example, have an index ellipsoid configuration with different refractive indices in a longer direction and a shorter direction with respect to a transmission light ray. Moreover, the alignment of the liquid crystal molecules 231 is changed in response to a voltage applied from the first transparent electrode 224 and the second transparent electrode 225. In this case, a refractive index with respect to a transmission light ray provided in a molecule alignment in a state in which a predetermined voltage as a differential voltage is applied to the liquid crystal molecules 231 is n0. Moreover, a refractive index with respect to a transmission light ray provided in a molecule alignment in a state in which the differential voltage is zero is ne. Further, the magnitudes of the refractive indices have a relationship of ne>n0. The refractive index of the replica 234 is equal to the refractive index n0 which is lower than the refractive index ne in the state in which the predetermined voltage as the differential voltage is applied to the liquid crystal molecules 231.

Thereby, in the state in which the differential voltage applied form the first transparent electrode 224 and the second transparent electrode 225 is zero, there is a difference between the refractive index ne of the liquid crystal molecules 231 with respect to a transmission light ray L and the refractive index n0 of the replica 234. As a result, as illustrated in FIG. 16, a part with a convex shape functions as a convex lens. On the other hand, in a state in which the differential voltage is the predetermined voltage, the refractive index n0 of the liquid crystal molecules 231 with respect to the transmission light ray L and the refractive index n0 of the replica 234 are equal to each other, and the part with the convex shape does not function as the convex lens. Thereby, as illustrated in FIG. 15, a light ray passing through the liquid crystal layer 223 is not deflected, and passes through as it is.

FIGS. 17A, 17B, 18 and 19, illustrate a second configuration example of the switching system lens array configured of liquid crystal lenses. As illustrated in FIGS. 17A and 17B, the lens array includes a first transparent substrate 101 and a second transparent substrate 102 which are made of, for example, a glass material, and a liquid crystal layer 103 sandwiched between the first substrate 101 and the second substrate 102. The first substrate 101 and the second substrate 102 are arranged so as to face each other with a distance d in between.

As illustrated in FIGS. 18 and 19, a first transparent electrode 111 configured of a transparent conductive film such as an ITO film is uniformly formed on substantially the whole surface on a side facing the second substrate 102 of the first substrate 101. Moreover, the second transparent electrode 112 configured of a transparent conductive film such as an ITO film is partially formed on a surface facing the first substrate 101 of the second substrate 102. As illustrated in FIG. 19, the second transparent electrode 112 has, for example, an electrode width L, and extends in a vertical direction. A plurality of the second transparent electrodes 112 are arranged in parallel at intervals corresponding to a lens pitch p when a lens effect is produced. A space between two adjacent second transparent electrodes 112 is an opening with a width A. In addition, in FIG. 19, to describe the arrangement of the second transparent electrodes 112, a state in which the switching system lens array is turned upside down, that is, the first substrate 101 is placed on an upper side, and the second substrate 102 is placed on a lower side is illustrated.

In addition, an alignment film (not illustrated) is formed between the first transparent electrode 111 and the liquid crystal layer 103. Moreover, an alignment film is formed between the second transparent electrodes 112 and the liquid crystal layer 103 in the same manner. As illustrated in FIG. 17A, the liquid crystal layer 103 does not have a lens-like shape illustrated in the configuration example in FIGS. 15 and 16, and liquid crystal molecules 104 having refractive index anisotropy are uniformly distributed.

In the lens array, as illustrated in FIG. 17A, in a normal state in which an applied voltage is 0 V, the liquid crystal molecules 104 are uniformly aligned in a predetermined direction determined by the alignment films. Therefore, a wavefront 201 of a transmission light ray is a plane wave, and the lens array is turned into a state with no lens effect. On the other hand, in the lens array, as illustrated in FIGS. 18 and 19, the second transparent electrodes 112 are arranged with the openings with the width A in between, so when a predetermined drive voltage is applied in a state illustrated in FIG. 18, an electric field distribution in the liquid crystal layer 103 is biased. More specifically, such an electric field that electric field strength increases according to the drive voltage in a part corresponding to a region where the second transparent electrode 112 is formed, and gradually degreases with decreasing distance to a central part of the opening with the width A is generated. Therefore, as illustrated in FIG. 17B, the arrangement of the liquid crystal molecules 104 is changed depending on an electric field strength distribution. Thereby, the wavefront 202 of the transmission light ray is changed so that the lens array is turned into a state in which a lens effect is produced.

In Japanese Unexamined Patent Application Publication No. 2008-9370, a liquid crystal lens in which a part corresponding to the second transparent electrode 112 in the electrode configuration illustrated in FIGS. 18 and 19 has a two-layer configuration is disclosed. In the liquid crystal lens, intervals between transparent electrodes in a first layer and a second layer in the two-layer configuration arranged on one side of a liquid crystal layer are different from each other, thereby the control of the electric field distribution formed in the liquid crystal layer is optimized more easily.

### SUMMARY OF THE INVENTION

However, in the case where the lens array illustrated in FIGS. 15 and 16 is used for switching between the two-dimensional display mode and the three-dimensional display mode, the following issues arise. First, it is necessary to form a mold to be filled with the liquid crystal molecules 231 on a substrate, and forming the mold is very disadvantageous in process and cost. Moreover, a state in which a lens effect is produced in the case where a voltage is not applied to the liquid crystal layer 223 is the three-dimensional display mode, but it is easily predicted that the two-dimensional display mode is more frequently used at present, so it is considered that it is disadvantageous in power consumption. Further, image display quality in the two-dimensional display mode is poor, because of a specific mold included in the liquid crystal layer 223 or viewing angle dependence of a liquid crystal.

On the other hand, in the case where the lens array illustrated in FIGS. 17A and 17B is used, a state in which a voltage is not applied to the liquid crystal layer 103 is a state with no lens effect, that is, the two-dimensional display mode. Therefore, in the case where the two-dimensional display mode is frequently used, it is advantageous in power consumption. Moreover, a lens-shaped mold is not included in the liquid crystal layer 103, so compared to the lens array illustrated in FIGS. 15 and 16, image display quality in the two-dimensional display mode is less prone to degradation.

In the case of a stationary display, typically the display states in a vertical direction and a horizontal direction of a screen are invariably fixed. For example, in the case of a stationary display having a landscape-oriented screen, the screen is invariably fixed to a landscape-oriented display state. However, for example, in a recent mobile device such as a cellular phone, a display in which the display state of a screen of a display section is switchable between a portrait orientation state (a state in which the screen has a larger length than a width) and a landscape orientation state (a state in which the screen has a larger width than a length) has been developed. Such switching between landscape-oriented display mode and the portrait-oriented display mode is achievable, for example, by rotating the device by 90° or independently rotating a display part in a display surface by 90°, and also rotating a display image by 90°. Now, it is considered to achieve three-dimensional display in such a device which is switchable between the portrait orientation state and the landscape orientation state. In the case of a system in which three-dimensional display is achieved with a cylindrical lens array which does not use liquid crystal lenses and is formed by resin molding, typically, the cylindrical lens array is fixed to a display surface of a two-dimensional display. Therefore, three-dimensional display is properly achieved in only one of the landscape orientation display state and the portrait orientation display state. For example, in the case where the cylindrical lens array is arranged so that three-dimensional display is properly achieved in the landscape orientation display state, in the portrait orientation display state, refractive power is provided in a vertical direction, but refractive power is not provided in a lateral direction, so it is difficult to properly achieve stereoscopic vision. Also in the case where a cylindrical lens array configured of liquid crystal lenses in related art is used, the same issue arises. More specifically, in related art, switching between the two-dimensional display mode and the three-dimensional display mode is allowed through the use of the liquid crystal lenses, but in the three-dimensional display mode, it is difficult to achieve appropriate display switching in response to switching between the landscape orientation display state and the portrait orientation display state.

Moreover, in the case where like the liquid crystal lens described in Japanese Unexamined Patent Application Publication No. 2008-9370, a two-layer electrode configuration is formed on one side of the liquid crystal layer, it is necessary to arrange two layers including electrodes, and it is extremely disadvantageous in process and cost. Moreover, as a device configuration, upper and lower substrates are electrically asymmetric to each other by a dielectric film separating the two layers including the electrodes on the top substrate. In other words, this state is the same as a state in which a thick alignment film is provided on the top substrate, and it is obvious that this state causes issues such as leading a burn-in phenomenon in a liquid crystal.

It is desirable to provide a lens array device allowing a lens effect of a cylindrical lens to be switched between two directions, and an image display using the lens array device.

According to an embodiment of the invention, there is provided a lens array device including: a first substrate and a second substrate arranged so as to face each other with a distance in between; a first electrode group formed on a side facing the second substrate of the first substrate and including a plurality of transparent electrodes extending in a first direction, the plurality of transparent electrodes being arranged in parallel at intervals in a width direction; a second electrode group formed on a side facing the first substrate of the second substrate and including a plurality of transparent electrodes extending in a second direction different from the first direction, the plurality of transparent electrodes being arranged in parallel at intervals in a width direction; and a liquid crystal layer arranged between the first substrate and the second substrate, including liquid crystal molecules having refractive index anisotropy, and producing a lens effect by changing the alignment direction of the liquid crystal molecules in response to voltages applied to the first electrode group and the second electrode group. The liquid crystal layer electrically changes into one of three states according to a state of the voltages applied to the first electrode group and the second electrode group, the three state including a state with no lens effect, a first lens state in which a lens effect of a first cylindrical lens extending in the first direction is produced and a second lens state in which a lens effect of a second cylindrical lens extending in the second direction is produced.

In the lens array device according to the embodiment of the invention, the liquid crystal layer electrically changes, according to the state of the voltages applied to the first electrode group and the second electrode group, into one of three states including the state with no lens effect, the first lens state in which the lens effect of the first cylindrical lens extending in the first direction is produced and the second lens state in which the lens effect of the second cylindrical lens extending in the second direction is produced. For example, all of the transparent electrodes in the first and second electrode groups are set into a same potential, so as to allow the liquid crystal layer to be turned into the state with no lens effect. A common voltage is applied to all of the transparent electrodes in the second electrode group and a drive voltage is selectively applied only to transparent electrodes, in the first electrode group, in positions corresponding to a lens pitch of the first cylindrical lens, so as to allow the liquid crystal layer to be turned into the first lens state. A common voltage is applied to all of the transparent electrodes in the first electrode group and a drive voltage is selectively applied only to transparent electrodes, in the second electrode group, in positions corresponding to a lens pitch of the second cylindrical lens, so as to allow the liquid crystal layer to be turned into the second lens state.

According to an embodiment of the invention, there is provided an image display including: a display panel two-dimensionally displaying an image; and a lens array device arranged so as to face a display surface of the display panel and selectively changing a transmission state of a light ray from the display panel. The lens array device is the lens array device according to the above-described embodiment of the invention.

In the image display according to the embodiment of the invention, for example, appropriate switching the state in the lens array device between the state with no lens effect and the first lens state or the second lens state allows electrical switching between two-dimensional display and three-dimensional display to be achieved. For example, putting the lens array device into the state with no lens effect allows display image light from the display panel to pass through the lens array device without any deflection, thereby to achieve two-dimensional display. Moreover, putting the lens array device into the first lens state allows the display image light from the display panel to be deflected in a direction orthogonal to the first direction, thereby to achieve three-dimensional display where a stereoscopic effect is obtained when both eyes of a viewer are placed along a direction orthogonal to the first direction. Further, putting the lens array device into the second lens state allows the display image light from the display panel to be deflected in a direction orthogonal to the second direction, thereby to achieve three-dimensional display where a stereoscopic effect is obtained when both eyes of the viewer are placed along a direction orthogonal to the second direction.

In the lens array device according to the embodiment of the invention, the first electrode group and the second electrode group are arranged so as to face each other with the liquid crystal layer in between, and the first electrode group and the second electrode group each include a plurality of transparent electrodes extending in two different directions, and the state of voltages applied to the first electrode group and the second electrode group is appropriately controlled so as to appropriately control a lens effect in the liquid crystal layer, so electrical switching between the presence and absence of the lens effect is easily allowed. Moreover, the lens effect of a cylindrical lens is easily electrically switchable between two directions.

In the image display according to the embodiment of the invention, as an optical device selectively changing the transmission state of a light ray from the display panel, the lens array device according to the embodiment of the invention is used, so, for example, electrical switching between two-dimensional display and three-dimensional display is easily allowed to be achieved. Moreover, for example, the display direction in the case where three-dimensional display is achieved is electrically easily switchable between two different directions.

Other and further objects, features and advantages of the invention will appear more fully from the following description.

### BRIEF DESCRIPTION OF THE DRAWINGS

FIG. 1 is a sectional view illustrating a configuration example of a lens array device according to a first embodiment of the invention.

FIG. 2 is a perspective view illustrating a configuration example of an electrode part of the lens array device according to the first embodiment of the invention.

FIG. 3 is an explanatory diagram illustrating a correspondence relationship between a voltage application state and a produced lens effect in the lens array device according to the first embodiment of the invention with a connection relationship of electrodes.

FIGS. 4A to 4C are explanatory diagrams optically equivalently illustrating switching states of the lens effect in the lens array device according to the first embodiment of the invention through the use of cylindrical lenses.

FIGS. 5A to 5D are explanatory diagrams illustrating an example of switching between display states in an image display according to a first embodiment of the invention.

FIG. 6 is an explanatory diagram illustrating a correspondence relationship between a voltage application state and a produced lens effect in a lens array device according to a second embodiment of the invention with a connection relationship of electrodes.

FIG. 7 is an explanatory diagram illustrating a correspondence relationship between a voltage application state in each electrode and a produced lens effect in the lens array device according to the second embodiment of the invention.

FIG. 8 is a waveform chart illustrating a drive voltage in the lens array device according to the second embodiment of the invention, and (A) and (B) illustrate a waveform of a first drive voltage and a waveform of a second drive voltage, respectively.

FIG. 9 is a waveform chart illustrating a potential between electrodes in a vertical direction in a second lens state (a Y-direction cylindrical lens), and (A) and (B) illustrate a voltage waveform of a part corresponding to a first electrode 21Y and a voltage waveform of a part corresponding to a second electrode 22Y in a second electrode group 24, respectively.

FIG. 10 is a waveform chart illustrating a potential between electrodes in a vertical direction in a first lens state (an X-direction cylindrical lens), and (A) and (B) illustrate a voltage waveform of a part corresponding to a first electrode 11X and a voltage waveform of a part corresponding to a second electrode 12X in a first electrode group 14, respectively.

FIG. 11 is a sectional view illustrating a configuration of an image display according to an example of the invention.

FIG. 12 is plan view illustrating a pixel configuration of an image display surface in the image display according to the example of the invention.

FIGS. 13A and 13B are plan views illustrating the size of an electrode in a lens array device in the image display according to the example of the invention.

FIG. 14 is an explanatory diagram of evaluation of visibility of three-dimensional display in the image display according to the example of the invention.

FIG. 15 is a sectional view of a first configuration example of a switching system lens array configured of liquid crystal lenses in a state with no lens effect.

FIG. 16 is a sectional view of the first configuration example of the switching system lens array configured of liquid crystal lenses in a state in which the lens effect is produced.

FIGS. 17A and 17B are sectional views illustrating a second configuration example of the switching system lens array configured of liquid crystal lenses in a state with no lens effect and in a state in which the lens effect is produced, respectively.

FIG. 18 is a sectional view illustrating a configuration example of an electrode part in the liquid crystal lens illustrated in FIGS. 17A and 17B.

FIG. 19 is a perspective view illustrating a configuration example of the electrode part in the liquid crystal lens illustrated in FIGS. 17A and 17B.

### DETAILED DESCRIPTION OF THE PREFERRED EMBODIMENTS

Preferred embodiment will be described in detail below referring to the accompanying drawings.

### First Embodiment

### Whole Configurations of Lens Array Device and Image Display

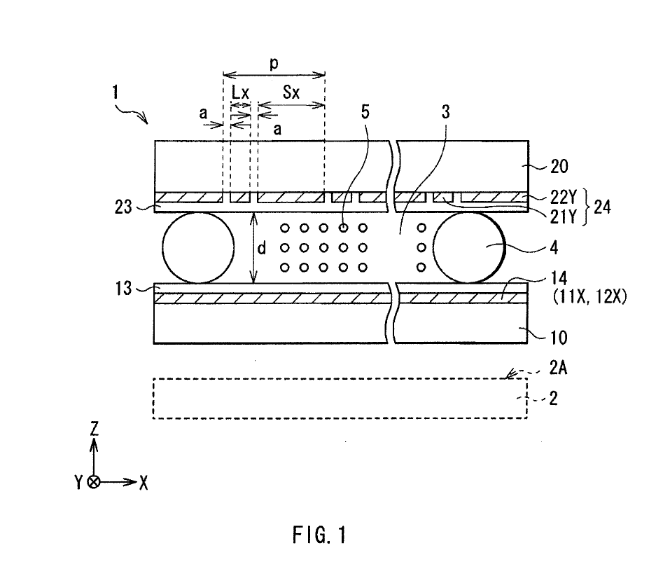

FIG. 1 illustrates a configuration example of a lens array device 1 according to a first embodiment of the invention. The lens array device 1 includes a first substrate 10 and a second substrate 20 which face each other with a distance d in between, and a liquid crystal layer 3 arranged between the first substrate 10 and the second substrate 20. The first substrate 10 and the second substrate 20 are transparent substrates made of, for example, a glass material or a resin material. A first electrode group 14 in which a plurality of transparent electrodes extending in a first direction are arranged in parallel at intervals in a width direction is formed on a side facing the second substrate 20 of the first substrate 10. An alignment film 13 is formed on the first substrate 10 with the first electrode group 14 in between. A second electrode group 24 in which a plurality of transparent electrodes extending in a second direction different from the first direction are arranged in parallel at intervals in the width direction is formed on a side facing the first substrate 10 of the second substrate 20. An alignment film 23 is formed on the second substrate 20 with the second electrode group 24 in between.

The lens array device 1 is combined with a display panel 2 two-dimensionally displaying an image so as to constitute, for example, an image display which is switchable between a two-dimensional display mode and a three-dimensional display mode. In this case, as illustrated in FIG. 1, the lens array device 1 is arranged so as to face a display surface 2A of the display panel 2. The lens array device 1 selectively changes the transmission state of a light ray from the display panel 2 by controlling a lens effect in response to a display mode. In this case, the display panel 2 is configured of, for example, a liquid crystal display. In the case where two-dimensional display is achieved, the display panel 2 displays an image based on two-dimensional image data, and in the case where three-dimensional display is achieved, the display panel 2 displays an image based on three-dimensional image data. In addition, the three-dimensional image data is data including a plurality of parallax images corresponding to a plurality of viewing angle directions in three-dimensional display. For example, in the case where binocular three-dimensional display is achieved, the three-dimensional image data is data including parallax images for right-eye display and left-eye display.

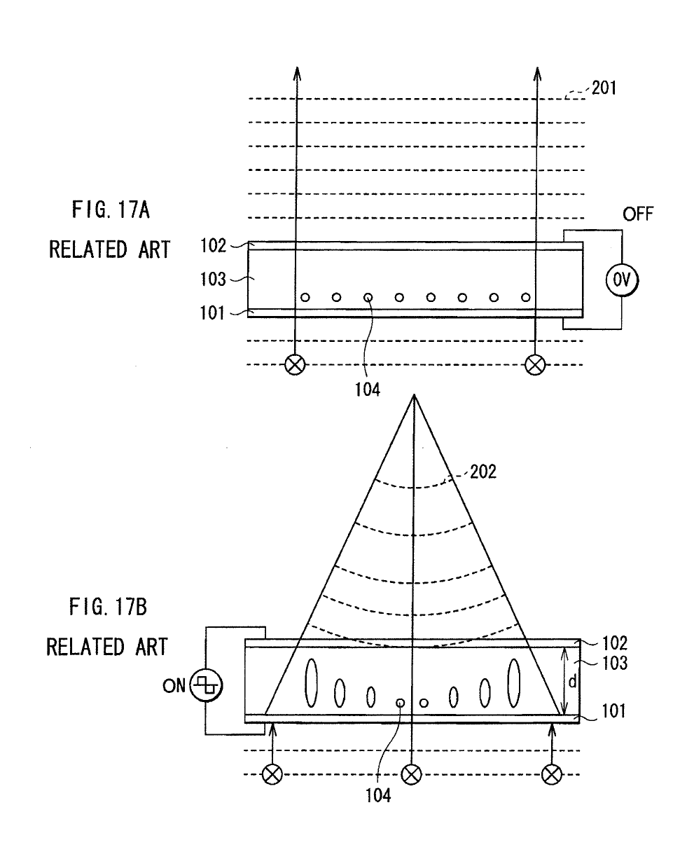

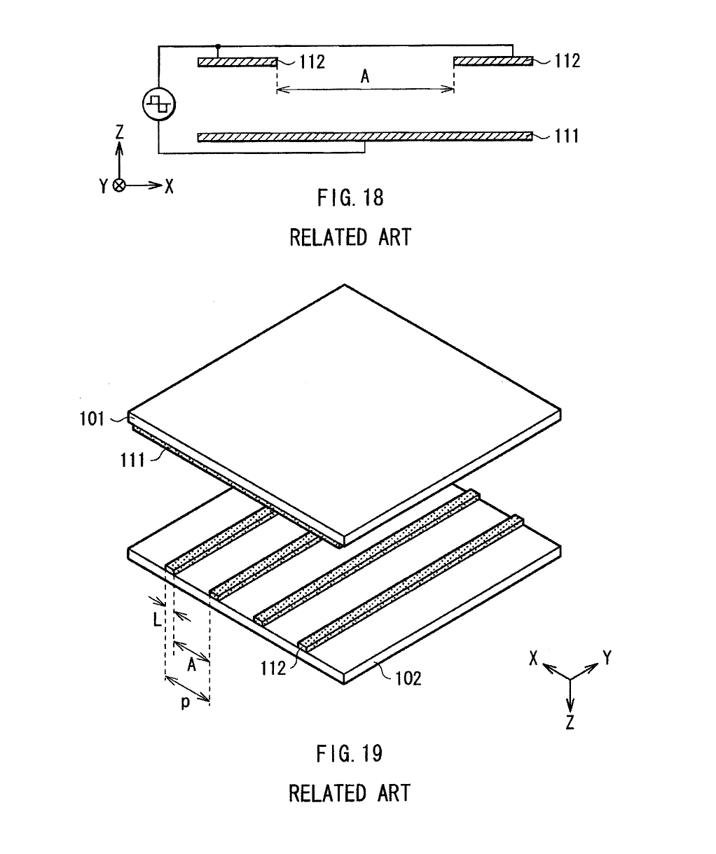

The liquid crystal layer 3 includes liquid crystal molecules 5, and a lens effect is controlled by changing the alignment direction of the liquid crystal molecules 5 in response to voltages applied to the first electrode group 14 and the second electrode group 24. The liquid crystal molecules 5 have refractive index anisotropy, and have, for example, an index ellipsoid configuration with different refractive indices with respect to a transmission light ray in a longer direction and a shorter direction. The liquid crystal layer 3 electrically changes into one of three states, that is, a state with no lens effect, a first lens state and a second lens state in response to a state of the voltages applied to the first electrode group 14 and the second electrode group 24. The first lens state is a state in which a lens effect of a first cylindrical lens extending in a first direction is produced. The second lens state is a state in which a lens effect of a second cylindrical lens extending in a second direction is produced. In addition, in the lens array device 1, the basic principle of the production of a lens effect is the same as that in a liquid crystal lens illustrated in FIGS. 17A and 17B, except that the lens array device 1 produces a lens effect by switching the direction of the lens effect between two different directions.

Hereinafter, in the embodiment, the above-described first direction is defined as an X-direction (a lateral direction of a paper plane) in FIG. 1, and the above-described second direction is defined as a Y-direction (a direction perpendicular to the paper plane) in FIG. 1. The X-direction and the Y-direction are orthogonal to each other in a substrate surface.

Electrode Configuration of Lens Array Device 1

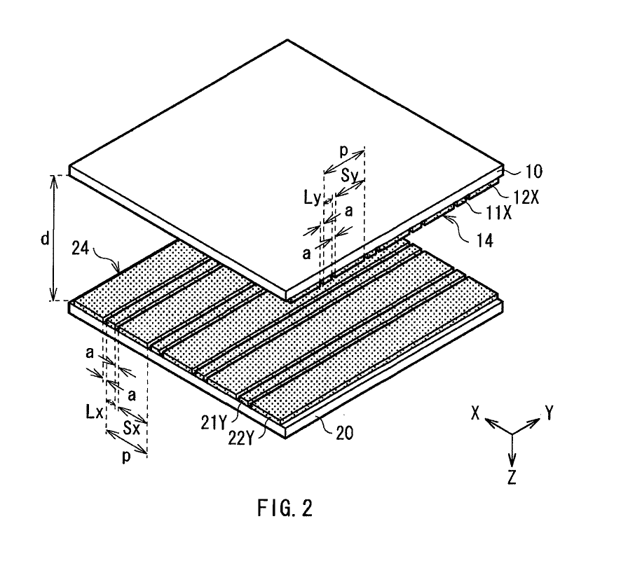

FIG. 2 illustrates a configuration example of an electrode configuration of the lens array device 1. In FIG. 2, to easily recognize a difference from an electrode configuration in related art illustrated in FIG. 19, a state in which the lens array device 1 in FIG. 1 is turned upside down, that is, the first substrate 10 is placed on an upper side, and the second substrate 20 is placed on a lower side is illustrated.

The first electrode group 14 has a configuration in which as a plurality of transparent electrodes, electrodes of two kinds having different electrode widths are alternately arranged in parallel. In other words, the first electrode group 14 has a configuration including a plurality of X-direction first electrodes (first electrodes 11X) and a plurality of X-direction second electrodes (second electrodes 12X) which are alternately arranged in parallel. The first electrodes 11X each have a first width Ly, and extend in the first direction (the X-direction). The second electrodes 12X each have a second width Sy larger than the first width Ly, and extend in the first direction. The plurality of the first electrodes 11X are arranged in parallel at intervals corresponding to a lens pitch p of the first cylindrical lens produced as a lens effect. The first electrodes 11X and the second electrodes 12X are arranged at intervals a.

The second electrode group 24 also has a configuration in which as a plurality of transparent electrodes, electrodes of two kinds having different electrode widths are alternately arranged in parallel. In other words, the second electrode group 24 has a configuration including a plurality of Y-direction first electrodes (first electrodes 21Y) and a plurality of Y-direction second electrodes (second electrodes 22Y) which are alternately arranged in parallel. The first electrodes 21Y each have a first width Lx, and extend in the second direction (the Y-direction). The second electrodes 22Y each have a second width Sx larger than the first width Lx, and extend in the second direction. The plurality of first electrodes 21Y are arranged in parallel at intervals corresponding to a lens pitch p of the second cylindrical lens produced as a lens effect. The first electrodes 21Y and second electrodes 22Y are arranged at intervals a.

Manufacturing Lens Array Device

When the lens array device 1 is manufactured, first, for example, transparent conductive films such as ITO films are formed in predetermined patterns on the first substrate 10 and the second substrate 20 made of, for example, a glass material or a resin material to form the first electrode group 14 and the second electrode group 24, respectively. The alignment films 13 and 23 are formed by a rubbing method in which a polymer compound such as polyimide is rubbed with a cloth in one direction or a method of oblique evaporation of SiO or the like. Thereby, the long axes of the liquid crystal molecules 5 are aligned in one direction. To keep a distance d between the first substrate 10 and the second substrate 20 uniform, a seal material into which a spacer 4 made of a glass material or a resin material is dispersed is printed on the alignment films 13 and 23. Then, the first substrate 10 and the second substrate 20 are bonded together, and the seal material including the spacer 4 is cured. After that, a known liquid crystal material such as a TN liquid crystal or an STN liquid crystal is injected between the first substrate 10 and the second substrate 20 from an opening of the seal material, and then the opening of the seal material is sealed. Then, a liquid crystal composition is heated to its isotropic phase, and then cooled slowly to complete the lens array device 1. In addition, in the embodiment, the larger the refractive index anisotropy Δn of the liquid crystal molecules 5 is, the larger lens effect is obtained, so the liquid crystal material preferably has such a composition. On the other hand, in the case of a liquid crystal composition having large refractive index anisotropy Δn, due to impairing physical properties of the liquid crystal composition to increase viscosity, it may be difficult to inject the liquid crystal composition between the substrates, or the liquid crystal composition may be turned into a state close to a crystal form at low temperature, or an internal electric field may be increased to cause an increase in a drive voltage for a liquid crystal element. Therefore, the liquid crystal material preferably has a composition based on both of manufacturability and the lens effect.

Control Operation of Lens Array Device

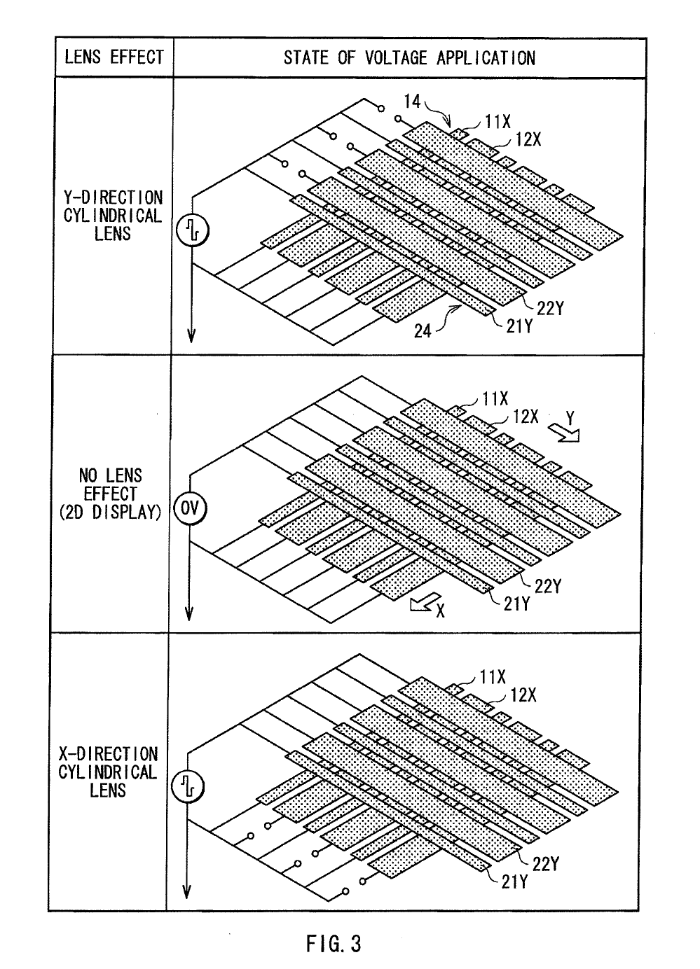

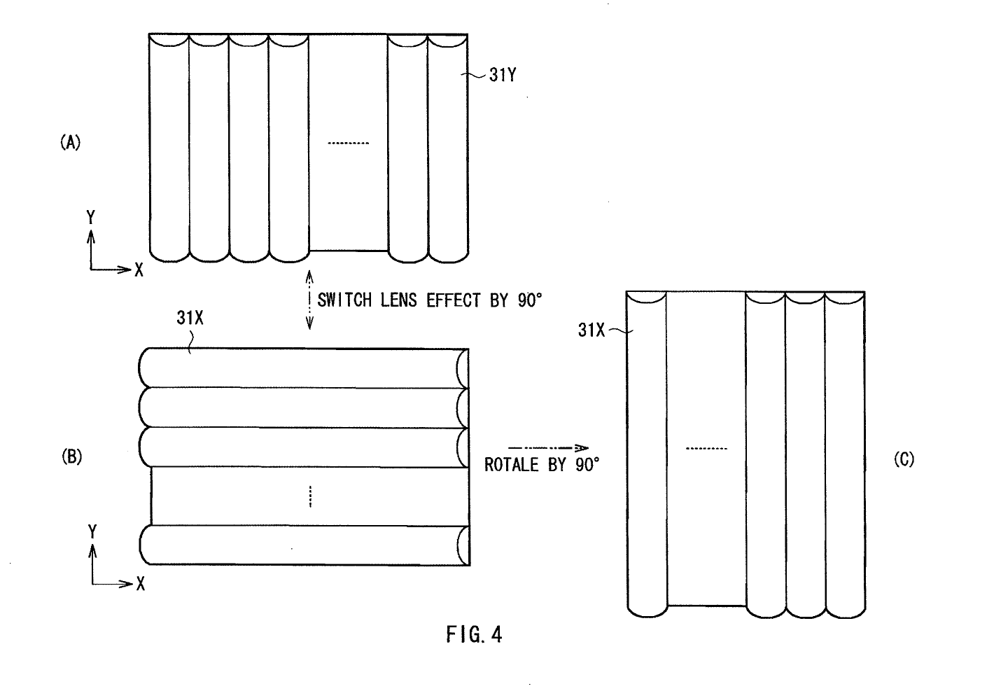

Next, referring to FIG. 3 and FIGS. 4A to 4C, the control operation of the lens array device 1 (the control operation of a lens effect) will be described below. FIG. 3 illustrates a correspondence relationship between a voltage application state and a produced lens effect in the lens array device 1 with a connection relationship of electrodes. FIGS. 4A to 4C optically equivalently illustrate a lens effect produced in the lens array device 1.

In the lens array device 1, the liquid crystal layer 3 electrically changes into one of three states, that is, the state with no lens effect, the first lens state and the second lens state according to a state of voltages applied to the first electrode group 14 and the second electrode group 24. The first lens state is a state in which the lens effect of the first cylindrical lens extending in the first direction (the X-direction) is produced. The second lens state is a state in which the lens effect of the second cylindrical lens extending in the second direction (the Y-direction) is produced.

In the lens array device 1, in the case where the liquid crystal layer 3 is turned into the state with no lens effect, a voltage is turned into a voltage state in which a plurality of transparent electrodes of the first electrode group 14 and a plurality of transparent electrodes of the second electrode group 24 have the same potential (0 V) (a state illustrated in a middle section in FIG. 3). In this case, the liquid crystal molecules 5 are uniformly aligned in a predetermined direction determined by the alignment films 13 and 23 by the same principle as that in the case illustrated in FIG. 17(A), so the liquid crystal layer 3 is turned into the state with no lens effect.

Moreover, in the case where the liquid crystal layer 3 is turned into the first lens state, a predetermined potential difference, which allows the alignment of the liquid crystal molecules 5 to be changed, between the transparent electrodes above and below the liquid crystal layer 3 is produced in parts corresponding to the first electrodes 11X of the first electrode group 14. For example, a common voltage is applied to all of the plurality of transparent electrodes (the first electrode 21Y and the second electrodes 22Y) of the second electrode group 24. At the same time, a predetermined drive voltage is selectively applied to only the first electrodes 11X of the plurality of transparent electrodes (the first electrodes 11X and the second electrodes 12X) of the first electrode group 14 (refer to a state illustrated in a bottom section in FIG. 3). In this case, an electric field distribution in the liquid crystal layer 3 is biased by the same principle as that in the case illustrated in FIG. 17B. More specifically, an electric field in which electric field strength increases according to the drive voltage in parts corresponding to regions where the first electrodes 11X are formed, and gradually degreases with increasing distance from the first electrodes 11X is generated. In other words, the electric field distribution is changed so as to produce a lens effect in the second direction (the Y-direction). As illustrated in FIG. 4B, the lens array device 1 is equivalently turned into a lens state in which a plurality of first cylindrical lenses (X-direction cylindrical lenses) 31X extending in the X-direction and having refractive power in the Y-direction are arranged in parallel in the Y-direction. In this case, a voltage is selectively applied to only transparent electrodes (the first electrodes 11X) in positions corresponding to a lens pitch p of the first cylindrical lenses 31X in the first electrode group 14.

Moreover, in the case where the liquid crystal layer 3 is turned into the second lens state, a predetermined potential difference, which allows the alignment of the liquid crystal molecules 5 to be changed, between the transparent electrodes above and below the liquid crystal layer 3 is produced in parts corresponding to the first electrodes 21Y of the second electrode group 24. For example, a common voltage is applied to all of the plurality of transparent electrodes of the first electrode group 14. At the same time, a predetermined drive voltage is selectively applied to only the first electrodes 21Y of the plurality of transparent electrodes constituting the second electrode group 24 (refer to a state illustrated in a top section in FIG. 3). In this case, an electric field distribution in the liquid crystal layer 3 is biased by the same principle as that in the case illustrated in FIG. 17B. More specifically, an electric field in which electric field strength increases according to the drive voltage in parts corresponding to regions where the first electrodes 21Y are formed, and gradually degreases with increasing distance from the first electrodes 21Y is generated. In other words, the electric field distribution is changed so as to produce a lens effect in the first direction (the X-direction). As illustrated in FIG. 4A, the lens array device 1 is equivalently turned into a lens state in which a plurality of second cylindrical lenses (Y-direction cylindrical lenses) 31Y extending in the Y-direction and having refractive power in the X-direction are arranged in parallel in the X-direction. In this case, a voltage is selectively applied to only transparent electrodes (the first electrodes 21Y) in positions corresponding to a lens pitch p of the second cylindrical lenses 31Y in the second electrode group 24.

In the first electrode group 14 and the second electrode group 24, the electrode widths (Ly, Lx and the like) or the intervals a between electrodes may be equal to each other (such as Ly=Lx). In this case, effects of cylindrical lenses having an equal lens pitch p and equal refractive power in different directions may be produced. On the other hand, when the first electrode group 14 and the second electrode group 24 have different electrode widths or different intervals a between electrodes, effects of cylindrical lenses having different lens pitches may be produced in the first lens state and the second lens state.

Control Operation of Image Display

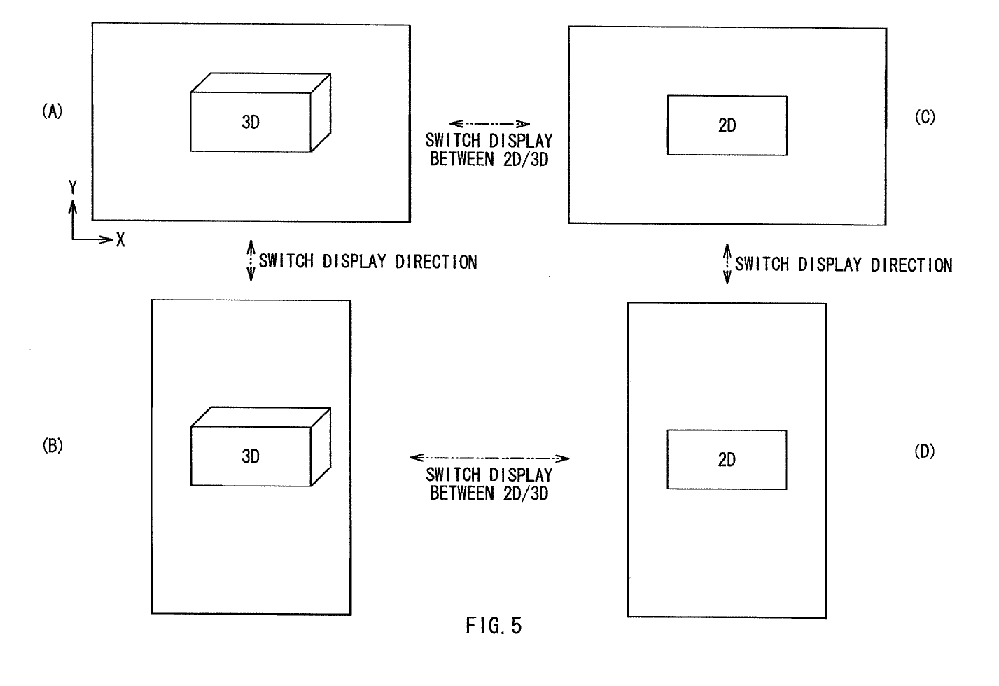

Referring to FIGS. 5A to 5D, the control operation of an image display using the lens array device 1 will be described below. FIGS. 5A to 5D illustrate an example of switching between display states in the image display. Herein, the case where, for example, the image display is applied to a device in which the display state of a screen is switchable between a portrait orientation state and a landscape orientation state such as a mobile device will be described below as an example. Also, the case where the image display is switchable between a two-dimensional display mode and a three-dimensional display mode will be described below as an example.

In the image display, electrical switching between two-dimensional display and three-dimensional display is achieved by appropriately switching among the state with no lens effect, the first lens state and the second lens state as described above. For example, when the lens array device 1 is turned into the state with no lens effect, display image light from the display panel 2 is not deflected and passes through as it is, thereby two-dimensional display is achieved. FIG. 5C illustrates a screen example in which two-dimensional display is achieved in a state in which the display state of the screen is landscape-oriented, and FIG. 5D illustrates a screen example in which two-dimensional display is achieved in a state in which the display state of the screen is portrait-oriented.

Moreover, when the lens array device 1 is turned into the first lens state, display image light from the display panel 2 is deflected in a direction (the Y-direction) orthogonal to the first direction (the X-direction), thereby three-dimensional display where a stereoscopic effect is obtained when both eyes of a viewer are placed along a direction orthogonal to the first direction is achieved. This corresponds to the case where three-dimensional display is achieved in a state in which the display state of the screen is portrait-oriented as illustrated in FIG. 5B. In this state, a lens effect in a state illustrated in FIG. 4C (a state in which a state illustrated in FIG. 4B is rotated by 90° is produced, so when both eyes are placed along a lateral direction in a state in which the display state of the screen is portrait-oriented, the stereoscopic effect is obtained.

Further, when the lens array device 1 is turned in the second lens state, display image light from the display panel 2 is deflected in a direction (the X-direction) orthogonal to the second direction (the Y-direction), thereby three-dimensional display where a stereoscopic effect is obtained when both eyes are placed along a direction orthogonal to the second direction. This corresponds to the case where three-dimensional display is achieved in a state in which the display state of the screen is landscape-oriented as illustrated in FIG. 5A. In this state, a lens effect in a state illustrated in FIG. 4A is produced, so when both eyes are placed along a lateral direction in a state in which the display state of the screen is landscape-oriented, the stereoscopic effect is obtained.

As described above, in the lens array device 1 according to the embodiment, when the state of the voltages applied to the first electrode group 14 and the second electrode group 24 is appropriately controlled, the lens effect in the liquid crystal layer 3 is appropriately controlled. Thereby, electrical switching between the presence and the absence of the lens effect is easily achieved. Moreover, the lens effect of the cylindrical lens is electrically easily switchable between two directions. In the lens array device 1, the electrode configurations facing each other with the liquid crystal layer 3 in between are single-layer configurations, so compared to the case where a two-layer electrode configuration is formed on one side of the liquid crystal layer as in the case of a liquid crystal lens described in Japanese Unexamined Patent Application Publication No. 2008-9370, the lens array device 1 is advantageous in process and cost. Moreover, a burn-in phenomenon of a liquid crystal caused in the case of the two-layer electrode configuration is preventable.

Further, in the image display according to the embodiment, as an optical device selectively changes the transmission state of a light ray from the display panel 2, the lens array device 1 is used, so electrical switching between the two-dimensional display and the three-dimensional display is easily achieved. Moreover, the display direction in the case where the three-dimensional display is achieved is electrically easily switchable between two different directions.

### Second Embodiment

Next, a lens array device and an image display according to a second embodiment of the invention will be described below. Like components are denoted by like numerals as of the lens array device 1 and the image display according to the first embodiment, and will not be further described.

In the lens array device 1 according to the first embodiment, in the case where the application states of the drive voltage to the transparent electrodes on an upper side and a lower side are implemented by a driving method illustrated in FIG. 3, there is a possibility that a lens shape (the alignment state of the liquid crystal molecules 5) is changed with time, thereby not to control the liquid crystal layer 3 into a desired lens state. In particular, in the case where a gap between electrodes (the distance d between substrates) is narrowed so as to achieve higher definition and higher response speed and the like, there is a high possibility that the liquid crystal layer 3 is not controlled into the desired lens state. For example, in a state illustrated in the top section in FIG. 3, only the first electrodes 21Y of the second electrode group 24 are connected to, for example, an external drive circuit so that a predetermined drive voltage is selectively applied to only the first electrodes 21Y, but the second electrodes 22Y are electrically isolated, and are in a floating state. In this case, when the lens array device 1 continuously operates, the second electrodes 22Y are in the floating state, so there is a possibility that the alignment of the liquid crystal molecules 5 in parts corresponding to the second electrodes 22Y is different from an initial condition, and is in an uncontrollable state. To maintain a good lens state in the state illustrated in the top section in FIG. 3, it is necessary to create a state in which the second electrodes 22Y act as if the second electrodes 22Y are not electrodes and the parts corresponding to the second electrodes 22Y are not electrically floated. The embodiment relates to an improvement in a method of driving the lens array device 1 according to the first embodiment. The basic configurations of the lens array device and the image display are the same as those in the first embodiment, so only the driving method will be described.

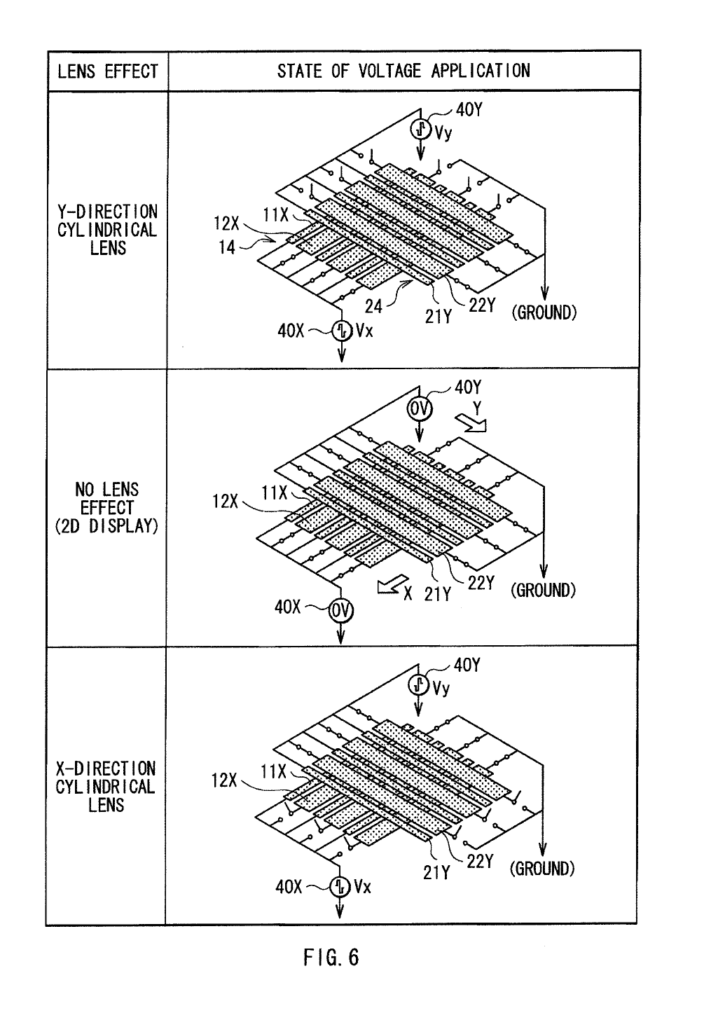

FIG. 6 illustrates a correspondence relationship between a voltage application state and a produced lens effect in the lens array device according to the embodiment with a connection relationship of electrodes. In the embodiment, one end of each of a plurality of transparent electrodes (the first electrodes 11X and the second electrodes 12X) in the first electrode group 14 is connectable to an X-direction signal generator (a first drive signal generator 40X) as a first external drive circuit. Moreover, one end of each of a plurality of transparent electrodes (the first electrodes 21Y and the second electrodes 22Y) in the second electrode group 24 is connectable to a Y-direction signal generator (a second drive signal generator 40Y) as a second external drive circuit.

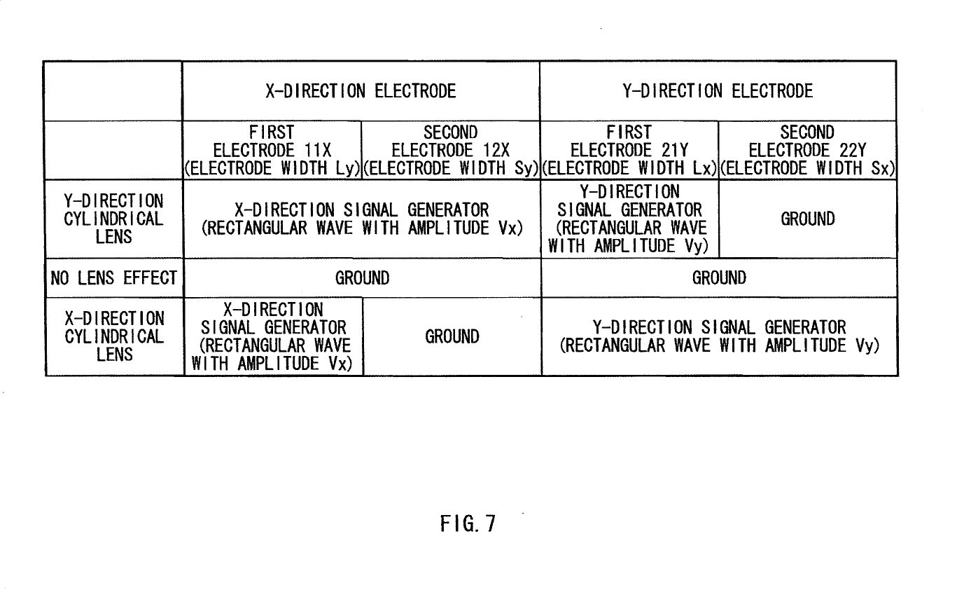

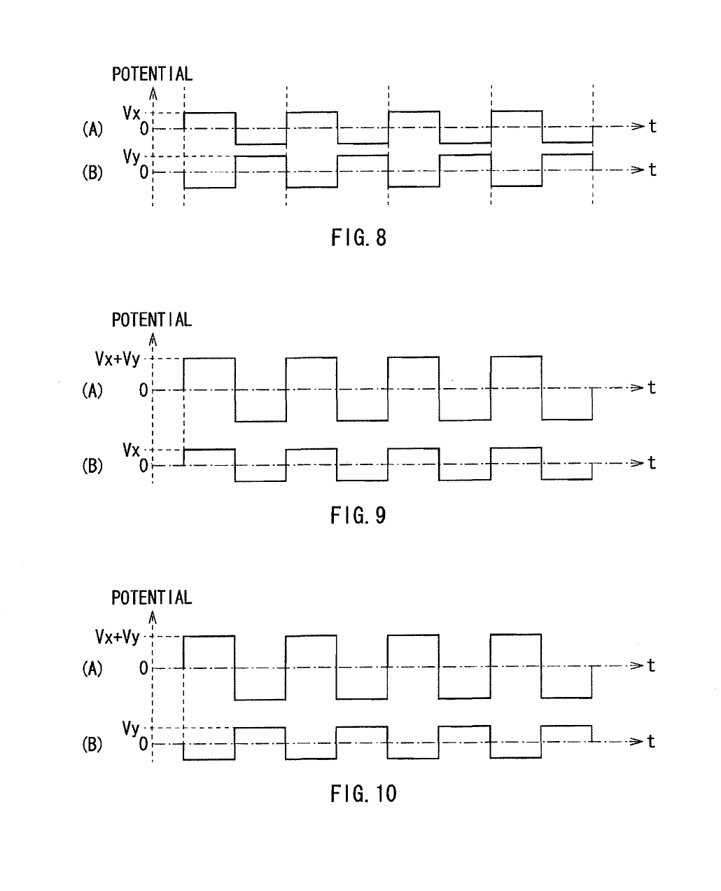

FIG. 7 illustrates a correspondence relationship between a voltage application state in each electrode and a produced lens effect in the lens array device. FIG. 8(A) illustrates an example of a voltage waveform of a drive signal (a first drive voltage (with an amplitude Vx)) generated by the first drive signal generator 40X in the case where the lens effect is produced in the lens array device. FIG. 8(B) illustrates an example of a voltage waveform of a drive signal (a second drive voltage (with an amplitude Vy)) generated by the second drive signal generator 40Y. The first drive signal generator 40× and the second drive signal generator 40Y each generate, for example, a signal of a rectangular wave with 30 Hz or over. As illustrated in FIGS. 8(A) and 8(B), the first drive signal generator 40× and the second drive signal generator 40Y generate drive signals with substantially equal amplitudes (Vx=Vy) and 180° different phases, respectively.

FIGS. 9(A) and 9(B) illustrate a potential between electrodes in a vertical direction in the second lens state (a top section in FIG. 6, a Y-direction cylindrical lens) in the embodiment. In particular, FIG. 9(A) illustrates a voltage waveform of a part corresponding to the first electrode 21Y of the second electrode group 24, and FIG. 9(B) illustrates a voltage waveform of a part corresponding to the second electrode 22Y. In the case where the liquid crystal layer 3 is turned into the second lens state, a predetermined potential difference, which allows the alignment of the liquid crystal molecules 5 to be changed, between the transparent electrodes above and below the liquid crystal layer 3 is produced in parts corresponding to the first electrodes 21Y of the second electrode group 24. First, one end of each of the plurality of transparent electrodes of the first electrode group 14 is connected to the first drive signal generator 40X, and a common voltage (the first drive voltage (with the amplitude Vx)) is applied to all of the electrodes. Moreover, only the first electrodes 21Y of the plurality of transparent electrodes of the second electrode group 24 are connected to the second drive signal generator 40Y, and a predetermined drive voltage (the second drive voltage (with the amplitude Vy)) is selectively applied to the first electrodes 21Y. At the same time, the second electrodes 22Y of the plurality of transparent electrodes of the second electrode group 24 are grounded. Thereby, compared to the state in the top section in FIG. 3, the second electrodes 22Y are prevented from being electrically floated. In this case, the first drive signal generator 40X and the second drive signal generator 40Y generate drive signals of rectangular waves with substantially equal voltage amplitude and 180° different phases, respectively, as illustrated in FIGS. 8(A) and 8(B). Therefore, as illustrated in FIG. 9(A), a rectangular wave having an amplitude voltage (Vx+Vy) is applied between the first electrodes 21Y of the second electrode group 24 and parts corresponding to the first electrodes 21Y of the first electrode group 14. On the other hand, as illustrated in FIG. 9(B), a rectangular wave having an amplitude voltage of Vx=Vy=(Vx+Vy)/2 is applied between the second electrodes 22Y of the second electrode group 24 and parts corresponding to the second electrodes 22Y of the first electrode group 14. At this time, in parts corresponding to the second electrodes 22Y, when the amplitude voltage is equal to or lower than a threshold voltage of the liquid crystal, the liquid crystal molecules 5 do not actually move, but a transverse electric field by the second electrodes 22Y is allowed to cause an initial alignment distribution of the liquid crystal molecules 5, that is, a refractive index distribution.

FIGS. 10(A) and 10(B) illustrate a potential between electrodes in the vertical direction in the first lens state (the bottom section in FIG. 6, the X-direction cylindrical lens). In particular, FIG. 10(A) illustrates a voltage waveform of a part corresponding to the first electrode 11X of the first electrode group 14, and FIG. 10(B) illustrates a voltage waveform of a part corresponding to the second electrode 12X. In the case where the liquid crystal layer 3 is turned into the first lens state, a predetermined potential difference, which allows the alignment of the liquid crystal molecules 5 to be changed, between the transparent electrodes above and below the liquid crystal layer 3 is produced in parts corresponding to the first electrodes 11X of the first electrode group 14. First, one end of each of the plurality of transparent electrodes of the second electrode group 24 is connected to the second drive signal generator 40Y, and a common voltage (the second drive voltage (with the amplitude Vy)) is applied to all of the transparent electrodes. Moreover, only the first electrodes 11X of the plurality of transparent electrodes of the first electrode group 14 are connected to the first drive signal generator 40X, and a predetermined drive voltage (the first drive voltage (with the amplitude Vx)) is selectively applied to the first electrodes 11X. At the same time, the second electrodes 12X of the plurality of transparent electrodes of the first electrode group 14 are grounded. Thereby, compared to the state in the bottom section in FIG. 3, the second electrodes 12X are prevented from being electrically floated. In this case, as illustrated in FIGS. 8(A) and 8(B), the first drive signal generator 40X and the second drive signal generator 40Y generate drive signals of rectangular waves with substantially equal voltage amplitudes and 180° different phases, respectively. Therefore, as illustrated in FIG. 10(A), a rectangular wave having an amplitude voltage (Vx+Vy) is applied between the first electrodes 11X of the first electrode group 14 and parts corresponding to the first electrodes 11X of the second electrode group 24. On the other hand, as illustrated in FIG. 10(B), a rectangular wave having an amplitude voltage of Vx=Vy=(Vx+Vy)/2 is applied between the second electrodes 12X of the first electrode group 14 and parts corresponding to the second electrodes 12X of the second electrode group 24. At this time, in parts corresponding to the second electrodes 12X, when the amplitude voltage is equal to or lower than the threshold voltage of the liquid crystal, the liquid crystal molecules 5 do not actually move, but a transverse electric field by the second electrode 12X is allowed to cause an initial alignment distribution of the liquid crystal molecules 5, that is, a refractive index distribution.

In the case where the liquid crystal layer 3 is turned into the state with no lens effect, a voltage is turned into a voltage state in which a plurality of transparent electrodes of the first electrode group 14 and a plurality of transparent electrodes of the second electrode group 24 have the same potential (0 V) (a state illustrated in the middle section in FIG. 6). That is, each electrode is grounded. In this case, the liquid crystal molecules 5 are uniformly aligned in a predetermined direction determined by the alignment films 13 and 23 by the same principle as that in the case illustrated in FIG. 17(A), so the liquid crystal layer 3 is turned into the state with no lens effect.

Thus, in the lens array device according to the embodiment, in the case where a lens effect is produced, the lens array device is driven so as not to cause electrical floating, so a change in the lens shape (the alignment state of the liquid crystal molecules 5) with time is preventable. Thereby, the lens array device is continuously controllable into a desired lens state.

### EXAMPLES

Next, specific examples of the image display using the lens array device 1 according to the embodiment will be described below.

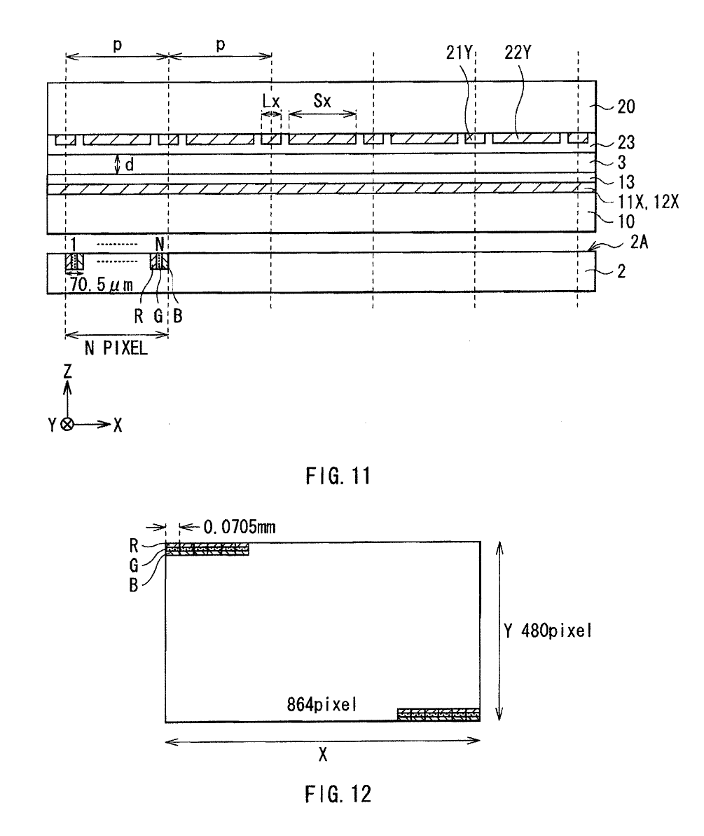

FIG. 11 illustrates a configuration of an image display according to examples. In the example, as the first substrate 10 and the second substrate 20 of the lens array device 1, electrode substrates formed by arranging transparent electrodes made of ITO on glass substrates were used. Then, by a known photolithography method and a wet etching method or a dry etching method, the electrodes are patterned into shapes of electrodes of the first electrode group 14 (the first electrodes 11X and the second electrodes 12X) and the second electrode group 24 (the first electrodes 21Y and the second electrodes 22Y). Polyimide was applied to the substrates by spin coating, and then polyimide was fired to form the alignment films 13 and 23. After firing the material, a rubbing process was performed on surfaces of the alignment films 13 and 23, and the alignment films 13 and 23 were cleaned with IPA or the like, and then dried by heating. After cooling down, the first substrate 10 and the second substrate 20 were bonded together with a distance d of approximately 30 to 50 μm in between so that rubbing directions thereof faced each other. The distance d was kept by dispersing a spacer on the whole surfaces. After that, the liquid crystal material was injected into the opening of the seal material by a vacuum injection method, and the opening of the seal material was sealed. Then, a liquid crystal cell was heated to its isotropic phase, and then cooled slowly. As the liquid crystal material used in the examples, MBBA (p-methoxybenzylidene-p′-butylaniline) which was a typical nematic liquid crystal was used. The value of refractive index anisotropy Δn was 0.255 at 20° C.

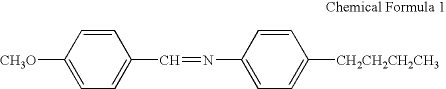

As the display panel 2, a TFT-LCD panel in which the size of one pixel was 70.5 μm was used. The display panel 2 included a plurality of pixels including R (red) pixels, G (green) pixels and B (blue) pixels, and the plurality of pixels were arranged in a matrix form. Moreover, the number of pixels in the display panel 2 with respect to the pitch p of the cylindrical lens formed by the lens array device 1 was an integral multiple such as N which was two or over. The number of light rays (the number of lines of sight) in three-dimensional display equal to the number N was provided.

Table 1 illustrates values of design parameters set as Examples 1 to 6. N indicates the number of pixels with respect to the lens pitch p of the display panel 2. The meanings of the widths Lx, Sx, Ly and Sy of electrodes, the interval a between electrodes, the distance d between substrates are as illustrated in FIG. 2. In addition, the configuration of the invention is not limited to the values of the design parameters indicated below in the examples.

TABLE 1

| | NUMBER | | | | | | | |
|---|---|---|---|---|---|---|---|---|
| EXAM- | OF | p | Lx | Sx | Ly | Sy | a | d |
| PLE | PIXEL N | (μm) | (μm) | (μm) | (μm) | (μm) | (μm) | (μm) |
| 1 | 4 | 282 | 45 | 217 | 45 | 217 | 10 | 50 |
| 2 | 4 | 282 | 45 | 217 | 45 | 217 | 10 | 30 |
| 3 | 4 | 282 | 20 | 242 | 20 | 242 | 10 | 50 |
| 4 | 2 | 141 | 20 | 111 | 20 | 111 | 5 | 30 |
| 5 | 2 | 141 | 20 | 111 | 20 | 111 | 5 | 10 |
| 6 | 2 | 141 | 10 | 121 | 10 | 121 | 5 | 30 |

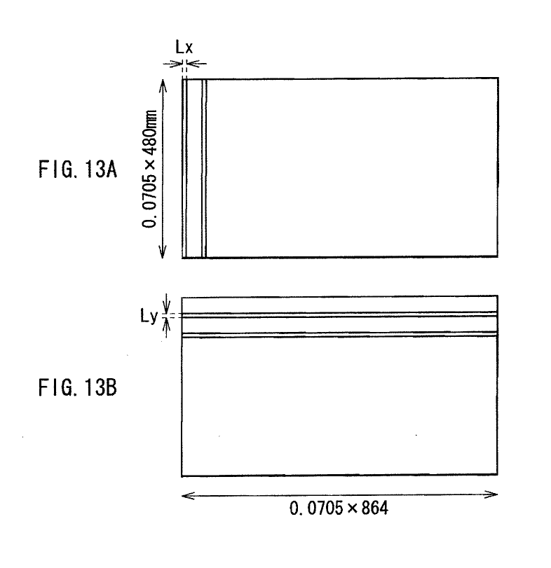

In Examples 1 to 6, as the display panel 2, a 3-inch WVGA (864×480 pixels) illustrated in FIG. 12 was used. FIGS. 13A and 13B illustrate electrode configurations of the lens array device 1 corresponding to the pixel configuration of the display panel 2 illustrated in FIG. 12. FIG. 13A illustrates an electrode configuration on the first substrate 10 side, and FIG. 13B illustrates an electrode configuration on the second substrate 20 side.

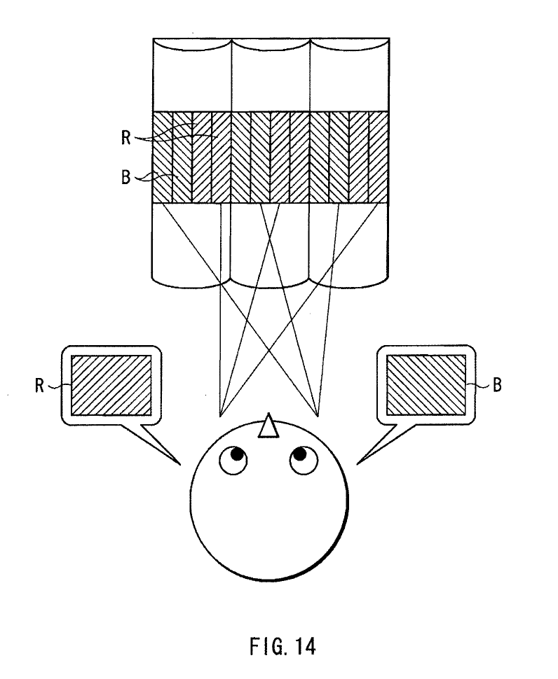

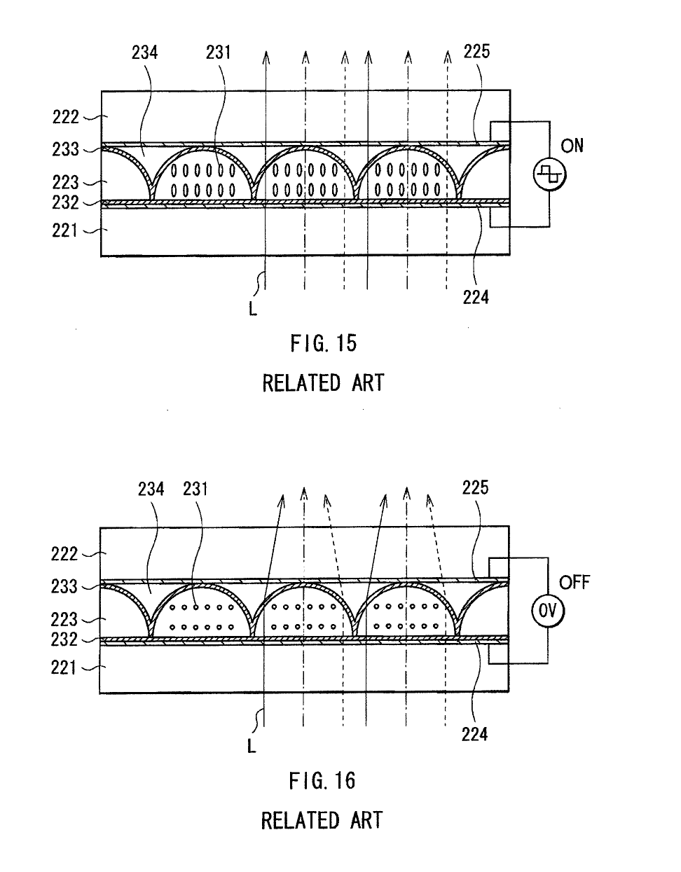

FIG. 14 illustrates the concept of evaluation of visibility of three-dimensional display in the examples. A specific testing means for judging three-dimensional display quality is not present, so in the examples, by the following evaluations, as criteria for judgment, whether or not three-dimensional display was recognizable was simply judged. In an example in FIG. 14, two blue pixels and two red pixels, that is, four pixels were allocated to one cylindrical lens formed in the lens array device 1. FIG. 14 is an image diagram corresponding to Examples 1 to 3. On the other hand, in Examples 4 to 6, one blue pixel and one red pixel, that is, two pixels were allocated to one cylindrical lens. In addition, FIG. 14 is a conceptual diagram, and in FIG. 14, the pixel shape and the like are different from those in FIGS. 11 and 12.

As conceptually illustrated in FIG. 14, display patterns were outputted to the display panel 2 so that the right eye and the left eye view blue and red, respectively. Cameras were placed in positions corresponding to the positions of the right eye and the left eye, and the display panel 2 was shot by the cameras, and as criteria for judgment, whether or not red and blue were separately viewed was judged. The evaluation was performed in the same manner in the case where the display screen was landscape-oriented and portrait-oriented. In addition, a drive amplitude voltage was gradually increased, and there was a region where visibility was not changed even if the voltage was increased, and a voltage value just below saturation was a drive voltage. Moreover, a time necessary for change from the three-dimensional display mode to the two-dimensional display mode (a 2D switching response time) was observed by applying 0 V. The results are illustrated in Table 2. In Table 2, “A” indicates a state in which red and blue were sufficiently separately viewed. “C” indicates a state in which a critical point at which red and blue were separated was viewed. “B” indicates that an intermediate state between the above states was viewed.

In the examples, a correspondence relationship between a voltage application state and a produced lens effect in the lens array device 1 was the same as that illustrated in FIG. 3 or 6. An external power supply used for voltage application used a rectangular wave of 30 Hz or over as a standard. The amplitude voltage at that time was approximately 5 V to 10 V, and was adjusted depending on the pitch of the cylindrical lens or a gap between upper and lower electrode substrates. It was necessary that the more the distance d between the substrates increased, the higher the amplitude voltage was set. As described above, in the case of using a second driving method illustrated in FIG. 6, the first drive signal generator 40X and the second drive signal generator 40Y generated drive signals with substantially equal voltage amplitudes (Vx=Vy) and 180° different phases, respectively. In the case of using a first driving method illustrated in FIG. 3, in each lens state, the voltage amplitude V of a rectangular wave applied to each electrode was V=2Vx=2Vy.

TABLE 2

| | RED/BLUE | RED/BLUE | | 2D SWITCHING |
|---|---|---|---|---|
| | SEPARATION | SEPARATION | AMPLITUDE | RESPONSE |
| | DISPLAY | DISPLAY | VOLTAGE | TIME |
| EXAMPLE | (LANDSCAPE) | (PORTRAIT) | (V) | (sec) |
| 1 | A | A | 7 | 2 |
| 2 | B | B | 5 | 1 |
| 3 | C | C | 7 | 2 |
| 4 | A | A | 5 | 1 |
| 5 | B | B | 4 | 0.5 |
| 6 | C | C | 5 | 1 |

The evaluations of basic visibility in the case of the first driving method illustrated in FIG. 3 and the case of the second driving method illustrated in FIG. 6 were the same as illustrated in Table 2. However, in the case where the lens array device 1 was continuously driven, changes in a liquid crystal distribution state with time (a change in the lens shape with time) occurred in the first driving method and the second driving method. Evaluations of the change with time depending on the driving methods are illustrated in Table 3. The degree of change was subjectively evaluated into three levels from a level where a good state was maintained without changing an initial lens shape with time to a level where variations occurred. In Table 3, “A” indicates a level where the lens shape was hardly changed, and “C” indicates a level where variations in lens shape occurred. “B” indicates an intermediate level between the above levels. It was obvious from Table 3 that in the first driving method, in the examples in which a gap between electrodes (the distance d between the substrates) was relatively narrow, the lens shape tended to be changed with time. On the other hand, in the second driving method, the lens shape was not changed with time in all of the examples.

TABLE 3
LIQUID CRYSTAL DISTRIBUTION STATE
(CHANGE IN LENS SHAPE WITH TIME)

| | FIRST DRIVING | SECOND DRIVING |
|---|---|---|
| EXAMPLE | METHOD | METHOD |
| 1 | B | A |
| 2 | C | A |
| 3 | B | A |
| 4 | B | A |
| 5 | C | A |
| 6 | C | A |

In addition, to have a faster response to switching to the two-dimensional display mode, it is necessary to reduce the gap between electrodes (the distance d between the substrates). On the other hand, the magnitude of the lens effect is influenced by the refractive index anisotropy Δn and the distance d between the substrates (Δn×d). Therefore, when a liquid crystal material with larger refractive index anisotropy Δn is used, the distance d between the substrates is allowed to be smaller than the distances d between the substrates in the examples.

### Other Embodiments

The present invention is not limited to the above-described embodiments and the above-described examples, and may be variously modified. For example, in the above-described embodiments and the above-described examples, the case where a direction where the lens effect is produced is switched by 90° is described. However, an angle by which the direction is switched is not limited to 90°, and may be any angle. For example, the direction of the lens effect of the cylindrical lens may be switched to a vertical direction and a direction shifted by a few degrees to a few tens degrees from the vertical direction. In this case, the first electrode group 14 and the second electrode group 24 may be formed at angles corresponding to the angle by which the direction of the lens effect is to be switched.

The present application contains subject matter related to that disclosed in Japanese Priority Patent Application JP 2008-326503 filed in the Japan Patent Office on Dec. 22, 2008 and Japanese Priority Patent Application JP 2009-063276 filed in the Japan Patent Office on Mar. 16, 2009, the entire content of which is hereby incorporated by references.

It should be understood by those skilled in the art that various modifications, combinations, sub-combinations and alterations may occur depending on design requirements and other factors insofar as they are within the scope of the appended claims or the equivalents thereof.

What is claimed is:

1. A lens array device comprising:
a first substrate and a second substrate arranged so as to face each other with a distance in between;
a first electrode group formed on a side facing the second substrate of the first substrate and including a plurality of transparent electrodes extending in a first direction, the plurality of transparent electrodes being arranged in parallel at intervals in a width direction;
a second electrode group formed on a side facing the first substrate of the second substrate and including a plurality of transparent electrodes extending in a second direction different from the first direction, the plurality of transparent electrodes being arranged in parallel at intervals in a width direction; and
a liquid crystal layer arranged between the first substrate and the second substrate, including liquid crystal molecules having refractive index anisotropy, and producing a lens effect by changing the alignment direction of the liquid crystal molecules in response to voltages applied to the first electrode group and the second electrode group,
wherein the liquid crystal layer electrically changes into one of three states according to a state of the voltages applied to the first electrode group and the second electrode group, the three state including a state with no lens effect, a first lens state in which a lens effect of a first cylindrical lens extending in the first direction is produced and a second lens state in which a lens effect of a second cylindrical lens extending in the second direction is produced.

2. The lens array device according to claim 1, wherein
all of the transparent electrodes in the first and second electrode groups are set into a same potential, so as to allow the liquid crystal layer to be turned into the state with no lens effect,
a common voltage is applied to all of the transparent electrodes in the first electrode group and a drive voltage is selectively applied only to transparent electrodes, in the second electrode group, in positions corresponding to a lens pitch of the second cylindrical lens, so as to allow the liquid crystal layer to be turned into the second lens state, and
a common voltage is applied to all of the transparent electrodes in the second electrode group and a drive voltage is selectively applied only to transparent electrodes, in the first electrode group, in positions corresponding to a lens pitch of the first cylindrical lens, so as to allow the liquid crystal layer to be turned into the first lens state.

3. The lens array device according to claim 1, wherein
the first electrode group includes a plurality of first electrodes (A1) having a first width and extending in the first direction and a plurality of second electrodes (A2) having a second width larger than the first width and extending in the first direction, the first electrodes and the second electrodes being alternately arranged in parallel, and
the second electrode group includes a plurality of first electrodes (B1) having a first width and extending in the second direction and a plurality of second electrodes (B1) having a second width larger than the first width and extending in the second direction, the first electrodes and the second electrodes being alternately arranged in parallel.

4. The lens array device according to claim 3, wherein
all of the transparent electrodes in the first and second electrode groups are set into a same potential, so as to allow the liquid crystal layer to be turned into the state with no lens effect,
a common voltage is applied to all of the transparent electrodes in the first electrode group, and a drive voltage is selectively applied only to the first electrodes (B1) in the second electrode group, so as to allow the liquid crystal layer to be turned into the second lens state, and
a common voltage is applied to all of the transparent electrodes of the second electrode group, and a drive voltage is selectively applied only to the first electrodes (A 1) in the first electrode group, so as to allow the liquid crystal layer to be turned into the first lens state.

5. The lens array device according to claim 4, wherein
the second electrodes (B2) of the second electrode group are grounded, so as to allow the liquid crystal layer to be turned into the second lens state, and
the second electrodes (A2) of the first electrode group are grounded, so as to allow the liquid crystal layer to be turned into the first lens state.

6. The lens array device according to claim 5, wherein
a first drive voltage is commonly applied to all of the transparent electrodes in the first electrode group and a second drive voltage is selectively applied only to the first electrodes in the second electrode group, so as to allow the liquid crystal layer to be turned into the second lens state,
the second drive voltage is commonly applied to all of the transparent electrodes in the second electrode group and the first drive voltage is selectively applied only to the first electrodes in the first electrode group, so as to allow the liquid crystal layer to be turned into the first lens state, and
the first drive voltage and the second drive voltage are applied as rectangular waves with equal voltage amplitudes and 180° different phases.

7. The lens array device according to claim 3, wherein
the first electrodes (A1) in the first electrode group are arranged at intervals corresponding to a lens pitch of the first cylindrical lens, and
the first electrodes (B1) in the second electrode group are arranged at intervals corresponding to a lens pitch of the second cylindrical lens.

8. The lens array device according to claim 1, wherein
the second direction is orthogonal to the first direction, and a state in which a lens effect is produced is electrically switched between the first direction and the second direction which are orthogonal to each other.

9. An image display comprising:
a display panel two-dimensionally displaying an image; and
a lens array device arranged so as to face a display surface of the display panel and selectively changing a transmission state of a light ray from the display panel,
wherein the lens array device includes:
a first substrate and a second substrate arranged so as to face each other with a distance in between,
a first electrode group formed on a side facing the second substrate of the first substrate and including a plurality of transparent electrodes extending in a first direction, the plurality of transparent electrodes being arranged in parallel at intervals in a width direction,
a second electrode group formed on a side facing the first substrate of the second substrate and including a plurality of transparent electrodes extending in a second direction different from the first direction, the plurality of transparent electrodes being arranged in parallel at intervals in a width direction, and
a liquid crystal layer arranged between the first substrate and the second substrate, including liquid crystal molecules having refractive index anisotropy, and producing a lens effect by changing the alignment direction of the liquid crystal molecules in response to voltages applied to the first electrode group and the second electrode group, and
the liquid crystal layer electrically changes into one of three states according to a state of the voltages applied to the first electrode group and the second electrode group, the three state including a state with no lens effect, a first lens state in which a lens effect of a first cylindrical lens extending in the first direction is produced and a second lens state in which a lens effect of a second cylindrical lens extending in the second direction is produced.

10. The image display according to claim 9, wherein
switching the state in the lens array device between the state with no lens effect and the first lens state or the second lens state allows electrical switching between two-dimensional display and three-dimensional display to be achieved.

11. The image display according to claim 10, wherein
putting the lens array device into the state with no lens effect allows display image light from the display panel to pass through the lens array device without any deflection, thereby to achieve two-dimensional display,
putting the lens array device into the first lens state allows the display image light from the display panel to be deflected in a direction orthogonal to the first direction, thereby to achieve three-dimensional display where a stereoscopic effect is obtained when both eyes of a viewer are placed along a direction orthogonal to the first direction, and
putting the lens array device into the second lens state allows the display image light from the display panel to be deflected in a direction orthogonal to the second direction, thereby to achieve three-dimensional display where a stereoscopic effect is obtained when both eyes of the viewer are placed along a direction orthogonal to the second direction.

12. An image display comprising:
a display panel displaying an image; and
a lens array device arranged so as to face a display surface of the display panel,
wherein the lens array device includes:
a first substrate and a second substrate arranged so as to face each other with a distance in between,
a first electrode group formed on a side facing the second substrate of the first substrate and including a plurality of transparent electrodes extending in a first direction,
a second electrode group formed on a side facing the first substrate of the second substrate and including a plurality of transparent electrodes extending in a second direction different from the first direction, and
a liquid crystal layer arranged between the first substrate and the second substrate,
wherein the liquid crystal layer electrically changes into one of three states according to a state of the voltages applied to the first electrode group and the second electrode group, the three state including:
a first state allows display image light from the display panel to be deflected in a direction orthogonal to the first direction,
a second state allows the display image light from the display panel to be deflected in a direction orthogonal to the second direction, and
a third state allows the display image light from the display panel to pass through the lens array device without any deflection.

13. The imaging display according to claim 12, wherein
a common voltage is applied to all of the transparent electrodes in the second electrode group and a drive voltage is selectively applied only to transparent electrodes in the first electrode group, so as to allow the liquid crystal layer to be turned into the first state,
a common voltage is applied to all of the transparent electrodes in the first electrode group and a drive voltage is selectively applied only to transparent electrodes in the second electrode group, so as to allow the liquid crystal layer to be turned into the second state, and
all of the transparent electrodes in the first and second electrode groups are set into a same potential, so as to allow the liquid crystal layer to be turned into the third state.
